(19) United States
(12) Patent Application Publication
(10) Pub. No.: US 2009/0254523 A1
(43) Pub. Date: Oct. 8, 2009

(54) HYBRID TERM AND DOCUMENT-BASED INDEXING FOR SEARCH QUERY RESOLUTION

(75) Inventors: Kevin Lang, Mountain View, CA (US); Swee Lim, Cupertino, CA (US); Choongsoon Chang, Palo Alto, CA (US)

Correspondence Address: YAHOO! INC.;c/o DUANE MORRIS LLP, Attn.: IP Docketing, 1 Market Plaza - 2000 Spear Tower, San Francisco, CA, 94105-1104, US

(73) Assignee: Yahoo! Inc., Sunnyvale, CA (US)

(21) Appl. No.: 12/098,376

(22) Filed: Apr. 4, 2008

(51) Int. Cl. G06F 17/30; G06F 7/10

(52) U.S. Cl. 707/3; 707/100; 707/2; 707/E17.008; 707/E17.032; 707/E17.014

(57) ABSTRACT

Methods and apparatuses relate to hosting an inverted index for term-based document searching. According to disclosed aspects, each bank of a plurality of banks receives a plurality of Document IDentifiers (DocIDs) in the inverted index, and within each bank, posting lists for each term are determined large or small. DocIDs for large posting lists are distributed among computers in a bank while responsibility for producing DocIDs identifiers in a small posting list are distributed by term to one or fewer computers in the bank. During operation, each term of a query is distributed to each bank, and then for small terms, only those computers assigned responsibility for a given term need to search for responsive DocIDs. DocIDs can be redistributed among computers in a bank such that results are presented from the computers that would have produced those results in a cluster having a pure DocIDs distribution scheme.

### BACKGROUND

1. Field

The present invention generally relates to search query resolution, and more particularly to resolving search queries, such as Internet searches, using clusters of computers.

2. Description of Related Art

Term-based searching of large databases to identify relevant or potentially relevant documents is an area of continued research and innovation. For example, Internet users provide term-based search queries to search engines accessing such databases to identify web pages that may be relevant to that query.

Because of the large number of data items (a.k.a. documents) available on the Internet (and even in particular portions of it, such as the World Wide Web), techniques to distribute indexing data for these documents and the work load of searching them for relevant terms have been developed.

To avoid actually searching documents responsively to each entered search query (which would result in unacceptable delays), an inverted index of terms appearing in the documents is provided. The inverted index provides a list of terms and a list of document identifications in which those terms appear. Each list of document identifications for a particular term is usually called a “posting list.” For some terms, the number of document identifications in the associated posting lists is very large, while for others terms, the number of documents in which those terms appear may be relatively small.

Also, the entire index itself can be too large to store and use efficiently in one computer system, so a cluster of computers may be provided to store and provide indexing services based on the inverted index. Since a cluster may comprise a plurality of physically distinct machines; ways to distribute the index among the machines of the cluster have been developed.

One way is a document-based distribution scheme. In a document-based distributed scheme, portions of the index are distributed among various computers of the cluster based on hashes of document identifiers, which are functionally unique for the purposes of identifying a particular document. In a DocID distribution scheme, portions of a given posting list (i.e., a list of DocIDs for a given term) are distributed among the cluster machines. At “run time”, when a query comes in, it is transmitted/broadcast to all machines in the cluster, which can then separately and in parallel process the query for its fraction of the DocIDs. Since each machine is responsible for a subset of the DocIDs, each machine processes all terms against its fraction of the DocIDs, and could return documents for which it has responsibility and in which one or more of the terms appear.

Another way to distribute the work load for a search among the computers of the cluster is a term-based distribution scheme. During index building for a term-based distribution, terms of the index are equally divided among the cluster's machines, by for example, using hashes of the term to obtain a term identifier (termID). At run time, a term from a query is sent only to the machines responsible for storing that particular term in that query. Each of those machines reads the entire posting list for the terms which are assigned to it and which appear in that query.

Further innovations in providing posting lists corresponding to search terms from cluster computers is desirable to increase throughput, decrease search latency, and manage costs of the machinery providing the search results.

### SUMMARY

Aspects include a method of distributing on a computing cluster an inverted index that comprises terms respectively associated with posting lists of document identifiers (DocIDs). The method comprises organizing m computers into B banks, and distributing document IDentifiers (DocIDs) appearing in posting lists of the inverted index among the B banks of computers, where each posting list corresponding to a search term. Within a bank of the B banks, the method includes distributing portions of the DocIDs, which appear in a large posting list and are distributed to that bank, to a plurality of the computers within that bank. Within each of the B banks, the method also comprises assigning responsibility for a small posting list to fewer of the computers of that bank, and providing for the distribution of DocIDs appearing in the small posting list, which are not already distributed to its assigned computers.

Further aspects include a computer cluster for providing searching of an inverted index comprising posting lists of document identifiers of documents in which each term of a plurality of terms appears, the computer cluster comprises m computers organized into B banks, where each computer is operable for storing data assigned to it, and wherein each computer of a respective bank stores a portion of document identifiers that are assigned to that bank and which are associated with a large posting list, and all the document identifiers assigned to that bank which are associated with a small posting list corresponding to a term assigned to that computer.

Further aspects include a method of providing a computer cluster for hosting an inverted index, comprising providing a plurality of banks of computers forming a computer cluster, obtaining an inverted index comprising a plurality of posting lists, where each posting list corresponds to a term, and comprises respective document identifiers (DocIDs) for one or more documents of a document set in which that term appears. The method also comprises distributing subsets of DocIDs for documents of the document set among respective banks of computers for storage on one or more computers therein.

For storing the subsets of DocIDs distributed to each bank, the method comprises identifying a larger posting list comprising DocIDs of the subset distributed to that bank, distributing the DocIDs of the larger posting list among plural computers of that bank, each of the plural computers for producing DocIDs of the larger posting list which were distributed to it, identifying a smaller posting list comprising DocIDs of the subset distributed to that bank, and assigning responsibility for producing DocIDs of the smaller posting list to fewer computers than the plural computers for the larger posting list.

A method of identifying documents potentially relevant to a term-based query, comprising receiving a query comprising search terms, using a computer cluster of m computers organized into B banks, the computer cluster hosting an inverted index comprising posting lists of DocIDs in which each term of a plurality of terms appears, and each computer of a respective bank stores a portion of DocIDs that are assigned to that bank and which are associated with a large posting list, and all the DocIDs assigned to that bank, which are associated with a small posting list corresponding to a term assigned to that computer. The method further comprises distributing the search terms to each bank. In each bank and for any term corresponding to a small posting list, the method comprise retrieving its corresponding smaller posting list from the computer to which it was assigned, and for any term corresponding to a large posting list, the method comprises retrieving a portion of its corresponding posting list from each computer of the bank.

Still further aspects include a method of organizing a computer cluster for supporting term-based searching of an inverted index, comprising: dividing m computers of the computer cluster into B banks and distributing selections of the document identifiers of an inverted index among the B banks. At least some of the document identifiers are distributed to fewer than all of the B banks. The method also comprises distributing the document identifiers assigned to each bank among the computers of that bank, wherein B is selected for balancing an aggregate search throughput of the computer cluster with respective search latencies for individual searches.

### BRIEF DESCRIPTION OF THE DRAWINGS

For a fuller understanding of aspects and examples disclosed herein, reference is made to the accompanying drawings in the following description.

FIG. 1 illustrates a first cluster architecture for an inverted index distributed on the cluster;

FIG. 2 illustrates method aspects of a first distribution of an index on the cluster of FIG. 1;

FIG. 3 illustrates aspects of a run-time method useful in the cluster of FIG. 1 as configured according to FIG. 2;

FIG. 4 illustrates a preferred hybrid distribution of an index on the cluster of FIG. 1;

FIG. 5 illustrates aspects of a run-time method useful in the cluster of FIG. 1 as configured according to FIG. 4; and

FIG. 6 illustrates data flow aspects for using the cluster of FIG. 1 as configured according to FIG. 4.

### DETAILED DESCRIPTION

The following description is presented to enable a person of ordinary skill in the art to make and use various aspects of the inventions. Descriptions of specific techniques, implementations and applications are provided only as examples. Various modifications to the examples described herein may be apparent to those skilled in the art, and the general principles defined herein may be applied to other examples and applications without departing from the scope of the invention.

An inverted index comprises lists of terms and corresponding lists of document identifiers (DocIDs) in which those terms appear. A collection of indications of what documents contain a given term is frequently called a posting list (e.g., a list of document identifiers). Thus, an inverted index is searchable by term to identify documents having that term. In the case of large document collections, there may be many documents that contain one term, and relatively few that contain another.

It was described in the background that a cluster of computers can be used to provide a capability to search an inverted index for lists of documents in which specified terms appear, and in such a cluster, each computer can take a part of producing DocIDs responsive to a query.

The document-based distribution strategy provides reduction in latency when producing large posting lists, because the DocIDs of a large posting list are produced in parallel by more computers. However, because the document-based distribution strategy calls for distributing documents among the computers based on DocIDs, DocIDs from any given posting list may actually be distributed among a large number of computers. Thus, generally, each computer in the system performs a seek to determine whether it has DocIDs for a term of a given search. Such a seek may include a hard-drive seek to load a list of DocIDs for a given term, which is orders of magnitude slower than indexing a solid state memory.

These seeks can cause waste of resources because some posting lists are comparatively small and so DocIDs of small posting lists may not be on a large number of computers, or the number of DocIDs on each computer may quite small. In such circumstances, the seeks on each computer that do not have relevant documents are wasted or cause a disproportionate waste of time for the amount of data produced. Of course, it may be possible to provide more and more resources for providing search capabilities in a given document collection, however, merely increasing resources can result in wasted money, in the form of capital expenditures, as well as increased maintenance costs and even utility bills. Therefore, it also is desirable to increase performance achievable with a cluster having a given number of computers.

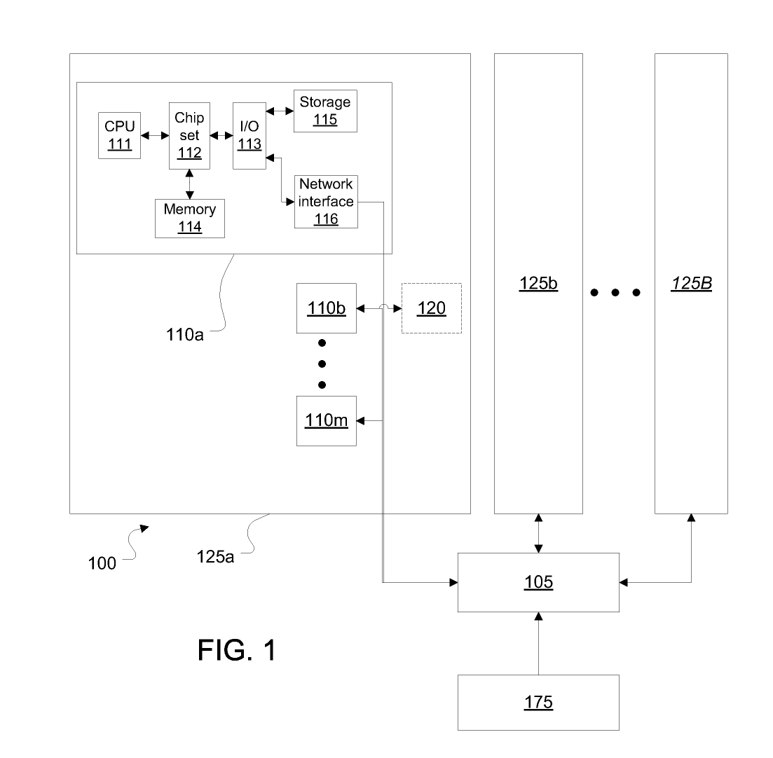

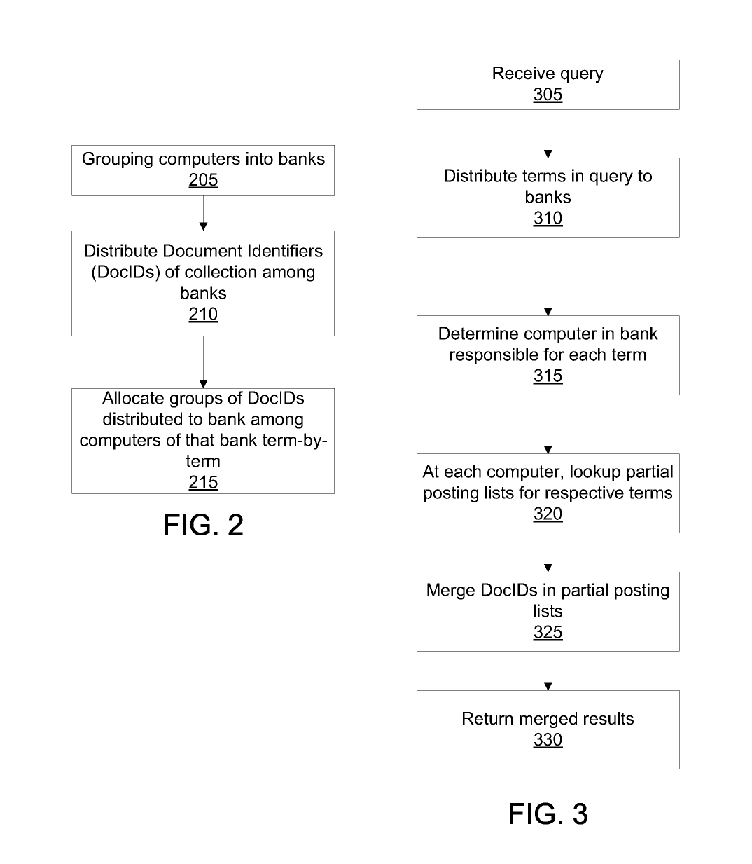

FIG. 1 illustrates a first exemplary cluster organization 100 (“cluster 100”) that seeks a balance between reducing latency for generation of large posting lists while also reducing unnecessary seeks induced by small posting lists. Cluster 100 contains m computers (illustratively numbered 110a-110m), organized into B banks 125a-125B. Although it may be preferable and/or intuitive that all B banks contain the same number of computers, there is no requirement that this be the case.

Each computer 110a-110m includes a storage resource, for example one or more hard drives, and/or flash drives, or even a virtual or logical partition in a dedicated storage unit, provided the storage unit could appropriately serve data within acceptable latencies to the computer using it as a storage resource. For example, in some cases, such a computer may be a rack-mount server having a RAID hard drive implementation that can be configured for data protection and/or data throughput (e.g., RAID 0, 1, 5, 10, etc.) Such aspects are illustrated in more detail with exemplary computer 110a, which comprises a processing resource 111, for example a central processing unit that may include a number of independently operable processing cores and other functional resources, a chipset 112, an I/O controller 113, a working memory 114 (e.g., system memory), network connectivity 116, and a storage resource 115, which may be interfaced to the I/O controller 113 using one or more of SATA, SCSI, Infiniband, Fibre Channel, Ethernet and a PCI-E connection, for example. Typically, such a computer 110a would not have a dedicated monitor or user interface, but usually would be controlled through a network management system.

A bank management server 120 can optionally be provided, which can coordinate operation of computers 110a-110m in each bank and interface with cluster management server 105. Where a bank-specific server 120 is not provided, a management process for each bank can execute on server 105 or on a designated computer in each bank 125a-125B. The number of banks (B) can be selected based on measurements of aggregate search throughput and samples of latencies for searches resulting in larger result sets. Thus, the number of banks (B) is increased to decrease individual search latencies, and B can be decreased to increase aggregate search throughput.

Cluster 100 can also be distributed geographically such that inter-computer and inter-bank links can be of any distance. For example, these connections may be long-haul fiber connections that carry virtual LAN traffic. On the other hand, different computers within a bank or within a cluster can actually be implemented as a portion of a larger computer, in that virtualization allows separate allocation of processing resources, and/or storage resources.

Now, for the purposes of this example, a document collection may have any number of documents, n documents. A document can be assigned a numerical Document Identifier (DocID) that can be any random or pseudorandom string of sufficient length to allow a high probability of distinctness among all DocIDs. Of course, other ways to construct DocIDs are acceptable, so long as an individual document can be identified with its ID.

Within these documents any number of terms, t terms, may appear. Here, a “term” may refer to a canonical term, which may include, for example, various forms of a given word, such as all tenses of a verb, or a stem for a number of words, or the like. For example, an inverted index for terms is depicted in table 1, where identifiers for a set of terms appear in a first column and in subsequent columns in that row, identifiers for specific documents in which that term appears are listed.

Table 1 depicts that some terms will have many associated DocIDs in its posting list while others may have a few. Of course, the scale of an actual implementation may be many orders of magnitude larger than this example. In present examples of systems and methods, DocIDs are distributed among servers, and their respective documents can be separately stored in another repository. This architecture can be selected because the size of posting lists for some terms can be so large that simply producing a list of DocIDs within an acceptable latency is sufficiently challenging. However, in other implementations, documents themselves can be stored with their DocIDs.

TABLE 1

| Terms | Documents | | | |
|---|---|---|---|---|
| Term ID1 | DocID114 | DocID150 | . . . | DocID161 |
| Term ID2 | DocID150 | DocID100450 | | |
| . | | . | | |
| . | | . | . . . | |
| . | | . | | |
| Term IDt | DocID2487 | DocID12345 | . . . | DocID24322 |

A method 200 for distributing DocIDs among a cluster 100 for the example of Table 1 according to a first aspect includes at least logically grouping 205 the m computers of cluster 100 into B banks. The number B of banks can be selected based on a desired balance between latency for larger posting lists and reducing unnecessary seeks for smaller posting lists, as will be explained in further detail below.

This grouping 205 can include, for example, providing a switch to locally interconnect computers of a given bank, and providing an uplink to a switch that serves all banks of cluster 100. Other ways to group 205 computers of cluster 100 into banks includes defining a VLAN for computers of a given bank, and maintaining a table of MAC addresses or IP addresses corresponding to a given bank. Such a table can be maintained by central server 105, for example. In other words, there is at least a logical hierarchy of computers within a bank and banks within cluster 100, but that hierarchy may not map directly into a hierarchy of physical connectivity.

Once there is at least some logical grouping of computers in cluster 100 into banks, the n DocIDs are distributed 210 among the banks. One way to divide DocIDs among the banks is to perform modulo division on some or all of a hash value derived from a given DocID by the number of banks, and discriminate among the banks based on the remainder of that modulo division.

After determining an allocation of DocIDs to banks, a further step is to allocate 215 the DocIDs of a given bank among the computers of that bank. Here, the allocation is a term-based allocation, and so allocation 215 may also involve an analysis to determine what terms appear in the DocIDs allocated to a bank, or such analysis can be performed in advance. For example, a hash can be performed on a term, to arrive at a hash value, and a number of bits of that hash value appropriate for the number of computers can be inspected to determine a computer of the bank to be responsible for producing DocIDs for that term (e.g., a partial posting list for that term) within that bank (e.g., by modulo division). Note that because a given term may appear in a number of documents whose respective DocIDs are allocated to a given bank, and every document in which a given term appears has a DocID distributed to a computer, there may be duplicates of DocIDs among the computers of a given bank.

Hence, the configuration of cluster 100 provides for DocIDs to be distributed among banks of cluster 100. Then, a determination of what terms appear in the documents grouped into each bank may be undertaken such that a subset of the computers in a given bank have responsibility for producing the portion of that term's posting list in that bank. (i.e., generally a subset of the DocIDs for a term's posting list will be allocated to a given bank by DocID, and then further allocated to computers in that bank term-by-term). In one aspect, responsibility for producing DocIDs in a posting list for a term, which are assigned to a given bank may be assigned to a single computer in that bank. In other aspects, such responsibility may be distributed among the plurality of computers in the bank, for example, two computers may be allocated responsibility for the DocIDs of a given term's posting list within a bank. For convenience, a partial posting list refers to any subset of a set of DocIDs appearing in a posting list. For example, for a term's posting list, partial posting lists can be created for each bank based on DocID allocation.

Generally the configuration of cluster 100 and allocation of DocIDs and distribution of responsibility for producing DocID results are performed “off-line”, because the documents and the terms indexed in those documents are expected to change much less frequently than a frequency of searches using that index. Thereafter, the “run time” method of searching the index (i.e., identification of documents that contain specified terms) is performed as described in FIG. 3 below.

FIG. 3 illustrates method 300 for producing DocIDs for documents containing terms included in a search query. A first query is received 305, the query contains one or more terms with the expectation that results relevant to those terms will be returned. The terms of the query are distributed 310 to all banks of cluster 100. Within each bank of cluster 100, it is determined 315, which computer of that bank is responsible for producing posting list results for each term of the query. This determination can be performed by an indexing process provided on the optional local management server 120 (FIG. 1). In absence of local management server 120, this determination 310 may be performed by a search query distribution process in server 105, which also interfaces with web front end 175. A further alternative is for each computer 110a-110m to store an index of terms for which it has partial posting list results in a main memory, so that access can be rapid, and does not require a hard drive seek.

Each computer responsible for a given term then performs a lookup 320 to identify DocIDs associated with that given term (e.g., usually, partial posting lists), and which were allocated to that bank. The identified DocIDs may be termed an initial result set, and may undergo preliminary processing to reduce a number of DocIDs returned. For example, each computer can process multiple terms and can intersect the partial posting lists it identified during lookup 320 to return non-duplicative results. Subsequently, each computer returns 325 identified DocIDs for its terms. The document results may then be received by the management server 120 for each bank, if present, and if not present then by management process(es) of server 105, which also would be receiving document results from other banks, potentially for the same terms as the document results returned from the bank described above. Management process within server 105 may then further process each DocID set to provide a final result set to other functionality used in producing a final search result.

Thus, each bank 125a-125B of cluster 100 would generally produce a portion of a posting list for a given term and within each bank only a subset of computers would have performed a seek to determine whether it contained or otherwise was responsible for returning DocIDs in a posting list for that term. This strategy reduces a number of seeks performed by the computers of cluster 100 while allowing posting list results to be returned by multiple computers in parallel, which reduces latency for large posting lists.

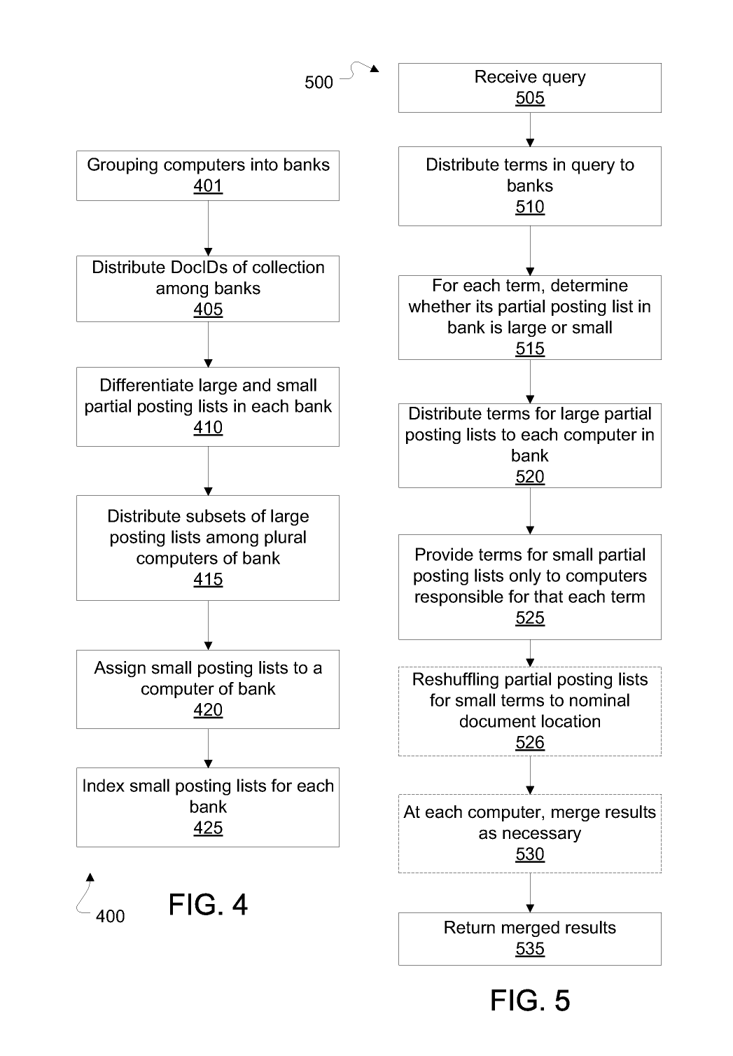

A second method 400 to distribute DocIDs among the computers of cluster 100 is explained with respect to FIG. 4. In the method 400, the available computers in the cluster are again grouped 401 into banks. The DocIDs for document collection are also distributed 405 among banks of cluster 100 according to document identifiers (e.g., modulo division on a hash value for each DocID). The method 400 also includes differentiating between (or otherwise, determining) 410 for DocIDs distributed to a given bank whether posting lists in which those documents appear are large or small. In other words, after distribution 405, determining 410 can include a term-based analysis of whether or not partial posting lists for a respective term have a large number of DocIDs distributed to a given bank. Alternatively, differentiating/determining 410 can be performed prior to distribution 405, such that a posting list for a given term can be judged large or small for the document collection as a whole, rather than for a portion of the document collection allocated to each bank. In such an example, this determination could control treatment of the partial posting lists in each bank for that term. In either case, within each bank, a term-by-term distinction between large versus small posting list is provided. This distinction between large versus small posting list is used to determine distribution of responsibility for producing posting list results within computers of a bank.

Within a given bank, subsets of DocIDs associated with a partial posting list considered large are distributed 415 among a plurality of computers in that bank. In an example, a subset of DocIDs is distributed to each computer of that bank. Alternatively to physically storing only a subset of DocIDs in each computer, DocIDs for the entire posting list can be stored in a plurality of computers and responsibility for producing a given subset of those DocIDs can be allocated to each computer. For example, if each computer had sufficient storage capacity for DocIDs of an entire document collection, then the additional effort to segment the DocIDs for that document collection among these computers may not be required, even though latency reduction in producing such documents may be desirable. This may be a practical matter, for example, where a hard drive of a larger size often costs only incrementally more than a hard drive substantially smaller.

For posting lists judged to be small, and within a bank, responsibility for producing DocIDs in that posting list and present in the bank, is assigned 420 to fewer computers, than for a large posting list. In an example, responsibility is assigned to only one computer of the bank, such that DocIDs for that small posting list present in that bank would be produced only by that one computer. Because any given DocID may be present both in large and in small posting lists, DocIDs may need to be duplicated among the computers of the bank. For example, in table 1 above, it was illustrated that DocID50 appeared in posting lists for both term 1 and term 2. Now assuming that DocID50 were assigned to bank 125a, and further assuming that the posting list for term 1 was determined to be large, at least within bank 125a, then DocID50 may be distributed to computer 110a, while responsibility for producing DocIDs present in the posting list for term 2 may be assigned to computer 110b. As such, DocID 50 may be duplicated on both computer 110a and computer 110b.

A “run time” method 500 for obtaining DocID results for term-based queries is illustrated in FIG. 5 and described below. In method 500, a query is received 505; such query can comprise a plurality of terms, for which relevant documents are desired. The terms of the query are distributed 510 to each bank, and it is determined 515 whether a partial posting list for each term in each bank is either large or small (determining 515 can also be performed globally for the entire document collection, such that a posting list for a term is either large or small in all banks). Terms with large posting lists are distributed 520 to each computer of the bank. Terms with small posting lists are provided 525 only to the computer(s) which was assigned responsibility for producing documents for that term's partial posting list. The optional step of reshuffling 526 is described below. After each computer has identified documents responsive to all the terms provided to it (e.g., some computers may have searched for documents of multiple partial posting lists, such as large and small partial posting lists, or multiple small posting lists), each computer can merge 530 those identified DocIDs to remove redundant DocIDs (e.g., multiple terms may appear in the same document). The merged are returned 535 to a management process in server 120 or server 105; if results are not merged, then some redundant results may be returned, which may be acceptable in some implementations.

The optional reshuffling step 526 may be applied to method 500 in the following circumstances. It was described in the background that is known to distribute DocIDs for posting lists among computers of a cluster according to a hash value. For example, in a 100 computer cluster, a computer to receive a document can be identified by Modulo (DocID, 100). In other words, it is known to distribute DocIDs listed in a posting list among a plurality of computers, and in such clusters, terms are distributed among all the computers of a cluster and those computers having part of a terms posting list (i.e., having DocIDs in a partial posting list for that term) respond with those DocIDs. In such clusters, each DocID can be said to have an actual home on the computer storing it. In the hybrid cluster described in some embodiments herein, it may be desirable to make the hybrid cluster (e.g., 100 machines organized into 5 banks) appear to higher-level systems as a pure document based distribution system. To do so, each DocID of a large posting list can have an actual home determined as Bank=DocID DIV 20, and Computer=DocID MOD 5. This arrangement effectively allows the distribution of DocIDs for large posting lists in a hybrid cluster to correspond with how those DocIDs would be distributed in a prior art document based distribution cluster.

However, in a hybrid cluster according to aspects disclosed herein, responsibility for producing results for small posting lists, within a bank, is assigned to select computers (in some examples, only 1 computer). For the above cluster example, DocIDs for a small posting list for a given TermID can be allocated to Bank=DocID DIV 20 and Computer=TermID MOD 5. So, if that computer returned its posting list for that TermID directly, it would be apparent that these results were not produced from a prior art document-based distribution cluster scheme.

Therefore, in further aspects, redistribution of partial posting list results within a bank for small posting lists can be undertaken prior to reporting results from a bank for a search. This redistribution may include, for a termID having a small posting list in a bank, sending DocIDs from a computer assigned to produce those postings to a computer that would have had those DocIDs in a document-based cluster scheme. For example, within a given bank, there may be distribution from a computer=TermID MOD 5 to computer=DocID MOD 5.

From the above disclosures, the following aspects concerning large posting lists in a document collection can be appreciated. First, a portion of DocIDs appearing in a given posting list will be distributed to each of the banks, and such portion can be termed a partial posting list for that term. Within each bank, there can be a 1:1 correspondence between responsibility for producing a defined portion of DocIDs of that partial posting list, and physical storage of those DocIDs.

From the above disclosures, the following aspects concerning small posting lists can be appreciated. First, a portion of DocIDs appearing in a small posting list may still be distributed among multiple banks, and therefore, each of these banks will have at least one computer responsible for returning results for such a posting list. Within each bank, responsibility for producing DocIDs of a partial small posting list can be distributed to one computer of the bank.

In sum, in this example, each bank receives a portion of DocIDs of a document collection, generally distributed according to DocID. Then, within a bank, large partial posting lists are distributed among all computers of that bank, and small partial posting lists are each assigned to one computer of that bank.

This example is a prototypical in the senses that posting lists are categorized as either large or small, and distribution according to this categorization is either to all computers in a bank or one computer. Other examples and implementations may provide more granular categorizations and assignments. For example, a number of degrees of a size for a partial posting list (i.e., a portion of a posting list present in a bank) can be established, and the larger a given partial posting list, the more computers within its bank will be assigned to produce DocIDs for it. Conversely, the smaller the partial posting list, the fewer the number of computers in a given bank will be assigned to produce postings for it. For example, posting lists for a document collection could be categorized as large/medium/small, or distributions of posting lists could be formed where a first quartile of the largest posting lists could be distributed to all of a bank's computers, and quartiles of smaller posting lists could be distributed to fewer computers within a bank. Where fewer than all computers of a bank store a partial posting list for a given term, then the computers having posting list contents relevant for the term associated with the partial posting list preferentially are indexed. Such indexing allows determination at run time which computers of a bank have data responsive to a given term.

Also, prototypically, portions of DocIDs for a document collection distributed to each bank may be approximately equal. However, this approximately equal distribution is an example, and distributions can also be made unequally among banks. For example, one bank may have more computing resources than another bank, or better network connectivity, etc. Such distinctions can be used in determining how to distribute DocIDs of a collection among banks in cluster 100.

In the above description, computers producing posting list results may first index a table based on a term to identify a list of document identifiers (DocIDs) that correspond to that term. These DocIDs can then be used to identify respective physical locations where the documents for each DocID are stored. Since documents sizes will vary, it may be convenient to provide an index of DocIDs to file locations, or alternatively an existing file system structure can be used such that DocIDs can serve as file names, and the file system itself can be used to obtain the document for each DocID.

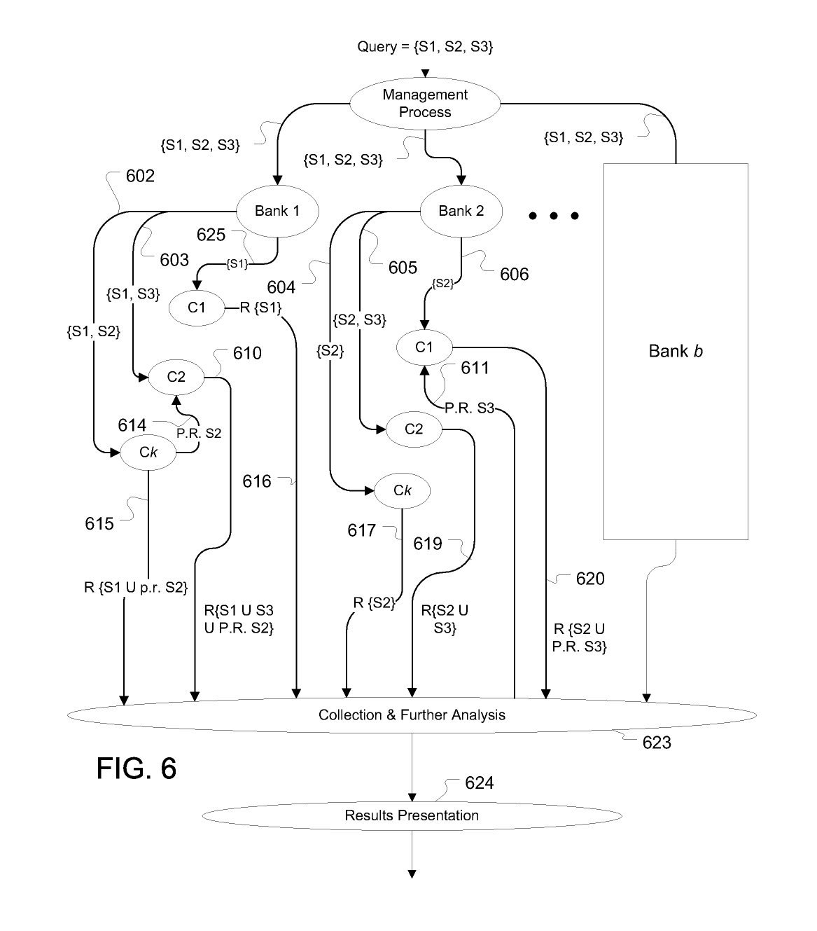

FIG. 6 illustrates an example dataflow diagram that summarizes aspects described above, for an example query comprising a set of three terms {S1, S2, S3}. The query is received by a management process and the terms of the query are distributed to Banks 1..b. In some implementations, all terms are distributed to each bank, as illustrated by distribution of the terms {S1, S2, S3} to each bank. Within each bank, it is determined which computers are assigned responsibility, or otherwise have stored partial posting lists responsive to each term. In an example, this determination can include determining a computer responsible for producing DocIDs in small posting lists. In this example, terms S2 and S3 were determined small. Following these determinations, terms are distributed to responsible computers within each bank. For example, in bank 1, 602 shows {S1, S2} to computer Ck, 603 shows {S1, S3} to C2 and 625 shows {S1] to C1. In bank 2, 604 shows {S2} to Ck, 605 shows {S2, S3} to C2, and 606 shows {S2} to C1. Similar operation would occur in bank b, but particulars are omitted in this example. Each computer in each bank then performs a seek to identify DocIDs in its partial posting list for that term (as described above, a given computer may actually be storing DocIDs containing a given term, but responsibility for producing those DocIDs in response to a query may be assigned to another computer in the bank or in a different bank). Then, each computer producing result sets as follows. C1 produces results as follows: 616 shows R {S1}, 615 shows the union of the result sets for terms S1 and a partial result for S2 R{S1 U p.r. S2} (i.e., computer Ck avoids producing duplicative DocIDs), and 614 shows a partial result for S2 being transmitted to computer C2.

In Bank 2, 604 shows {S2} transmitted to Ck, 605 shows {S2, S3} transmitted to C2, and 606 shows {S2} to C1. The computers of Bank 2 produce results as follows: 617 shows R {S2}, 619 shows R {S2 U S3}, 611 shows that partial results from C2 are sent from the collection point (e.g., a management process) to C1, which are then shown in 620 as being returned with other results R {S2 U P.R. S3} from C1. The operation of C2 and C1 in Bank 2 with respect to results for S3 illustrate a different way to maintain transparency of origin of results for terms searching. Rather than sending from one computer in a bank to another partial results that would have been resident on the destination computer in a document-based cluster, a given computer can send all results to a management process (e.g., 619 shows returning a union of results for S2 and S3 from C2), and the management process can identify portions of results that would have been from different computers in a bank, and can send those results to those computers (e.g., as shown by 611, where partial results for S3 are sent to C1). In this example, bank 2 is not producing posting results for S1, which would imply that documents in which S1 appears are distributed to banks other than bank 2. For posting lists of most practical sizes, this result may be statistically unlikely, but nevertheless possible. However, all the terms of a given search query can be distributed to all banks, such that control over posting list distribution in the bank can remain more localized.

Thus, results from all the banks of the cluster are collected and analyzed (623). Typically, such analysis would further narrow the results based on any of a variety of algorithms and the results from 623 would then be presented 624. For example, the results can be provided to a user, saved, and/or transmitted. Since the hybrid cluster can provide DocIDs for any type of further use, the particulars of such use need not be described.

In hybrid indexing clusters according to disclosed aspects, it will be the case that not all computers of a bank will be involved in each search processed by the cluster, or by that bank. Therefore, query scheduling algorithms can be provided based on how terms are allocated within each bank. For example, a bank can determine that two terms of two different queries are assigned to different computers and may schedule those terms for servicing simultaneously.

Many variations and enhancements to the examples and aspects disclosed herein will be apparent to those of ordinary skill in the art in view of these disclosures, and all such variations and enhancements should therefore be considered within the scope of the appended claims and their equivalents.

We claim:

1. A method of distributing on a computing cluster an inverted index comprising terms respectively associated with posting lists of document identifiers (DocIDs), comprising:
organizing n computers into B banks;
distributing document IDentifiers (DocIDs) appearing in posting lists of an inverted index among the B banks of computers, each posting list corresponding to a search term;
within a bank of the B banks, distributing portions of the DocIDs, which appear in a large posting list and are distributed to that bank, to a plurality of the computers within that bank;
within that bank, assigning responsibility to produce posting list results for a small posting list term to fewer of the computers of that bank; and
providing for the distribution of DocIDs appearing in the small posting list, which are not already distributed thereto, to its assigned computer(s).

2. The method of claim 1, wherein a posting list is determined large by determining that the posting list has more than T DocIDs and a posting list is determined small by determining that the posting list has no more than T DocIDs.

3. The method of claim 1, wherein a posting list is determined large by determining that the posting list has at least T DocIDs.

4. The method of claim 1, further comprising distributing documents according to modulo division of a portion of a hash of a DocID with B.

5. The method of claim 1, wherein a given one of the banks includes k computers, and distribution of terms in that bank is based on modulo division of a hash value for each term divided modulo by k.

6. The method of claim 1, wherein assigning responsibility for the small posting list comprises using a hash value for a term to which the small posting list corresponds to determine the computer to which responsibility is assigned.

7. The method of claim 1, further comprising, providing, for each bank, a small term index mapping assignments of small posting lists to computers of that bank.

8. The method of claim 7, further comprising storing the small term index on one of the computers in the bank.

9. The method of claim 1, further comprising determining, bank-by-bank, whether a posting list portion for a given term is small in that bank.

10. A computer cluster for providing searching of an inverted index comprising posting lists of document identifiers of documents in which each term of a plurality of terms appears, comprising:
n computers organized into B banks, each computer operable for storing data assigned to it, wherein
each computer of a respective bank stores a portion of document identifiers that are assigned to that bank and which are associated with a large posting list, and
all the document identifiers assigned to that bank which are associated with a small posting list corresponding to a term assigned to that computer.

11. The computer cluster of claim 10, further comprising an index mapping small posting list terms to the respective computer to which they were assigned.

12. The computer cluster of claim 10, wherein the portion of document identifiers assigned to that bank were assigned based on a hash value derived from the document identifier.

13. The computer cluster of claim 10, wherein the term was assigned based on a hash value derived from the term.

14. A method of identifying documents potentially relevant to a term-based query, comprising:
receiving a query comprising search terms;
using a computer cluster of n computers organized into B banks, the computer cluster hosting an inverted index comprising posting lists of DocIDs in which each term of a plurality of terms appears, and each computer of a respective bank stores a portion of DocIDs that are assigned to that bank and which are associated with a large posting list, and all the DocIDs assigned to that bank, which are associated with a small posting list corresponding to a term assigned to that computer;
distributing the search terms to each bank; and
in each bank,
for any term corresponding to a small posting list, retrieving its corresponding smaller posting list from the computer to which it was assigned, and
for any term corresponding to a large posting list, retrieving a portion of its corresponding posting list from each computer of the bank.

15. The method of claim 14, further comprising collecting retrieved posting lists results at each computer and at each bank.

16. A method of organizing a computer cluster for supporting term-based searching of an inverted index, comprising:
dividing n computers of the computer cluster into B banks;
distributing selections of document identifiers of an inverted index among the B banks, wherein at least some of the document identifiers are distributed to fewer than all of the B banks; and
distributing the document identifiers assigned to each bank among the computers of that bank, wherein B is selected for balancing an aggregate search throughput of the computer cluster with respective search latencies for individual searches.

17. The method of claim 16, further comprising adjusting B based on measurements of aggregate search throughput and samples of latencies for searches resulting in larger result sets.

18. The method of claim 16, wherein B is increased to decrease individual search latencies.

19. The method of claim 16, wherein B is decreased to increase aggregate search throughput.

20. The method of claim 16, further comprising receiving a search request comprising one or more search terms, distributing the search request among the B banks, determining which computer or computes in each bank was distributed each of the search terms and producing a posting list for each search term from those computers.

21. The method of claim 20, further comprising aggregating respective posting list results for each search term from each bank within a management process.
